(19) United States
(12) Patent Application Publication
(10) Pub. No.: US 2018/0176827 A1
(43) Pub. Date: Jun. 21, 2018

(54) MANAGEMENT OF RESOURCE ALLOCATION IN A MOBILE TELECOMMUNICATION NETWORK

(71) Applicant: VODAFONE IP LICENSING LIMITED, London (GB)

(72) Inventors: Susana SABATER MAROTO, London (GB); Aldo ARTIGIANI, London (GB); Roberto VERCELLI, London (GB); Valerio CECI, London (GB)

(21) Appl. No.: 15/125,426

(22) PCT Filed: Mar. 13, 2015
(86) PCT No.: PCT/GB2015/050748

§ 371 Date: Sep. 12, 2016

(30) Foreign Application Priority Data
Mar. 13, 2014 (GB) 1404504.1

(51) Int. Cl. H04W 28/16; H04W 72/04; H04W 24/04; H04W 36/38

(52) U.S. Cl. CPC H04W 28/16; H04W 72/0493; H04L 41/0654; H04W 24/04; H04W 36/38; H04W 72/0486

(57) ABSTRACT

A network entity (100) for managing resource allocation in a mobile telecommunication network comprise a first interface (101) configured to enable the network entity (100) to communicate with one or more cloud managing entities (10), wherein each of the one or more cloud managing entities (10) manages respective remote resources, and a second interface (102) configured to enable the network entity (100) to control operations between one or more network managing entities (20) and the one or more cloud managing entities (10), wherein each of the one or more network managing entities (20) manages respective network elements. Said network entity (100) is configured to exchange information with said one or more cloud managing entities (10) over said first interface (101) and control the operations between said one or more network managing entities (20) and said one or more cloud managing entities (10) based on said information, said information comprising a status of at least one of the respective remote resources (50) managed by said one or more cloud managing entities (10).

### FIELD OF THE INVENTION

The present invention relates to the field of mobile telecommunication networks. In particular, the present invention relates to a network entity for managing resource allocation in a mobile telecommunication network.

The present invention also relates to a system for managing resource allocation in a mobile telecommunication network.

### BACKGROUND OF THE INVENTION

Nowadays various telecommunication network infrastructure suppliers provide telecommunication network service providers with monolithic or closed resource systems consisting of network nodes with proprietary management systems. This means that several proprietary systems are existing within the telecommunication provider's network and providing capacity to the network.

Whenever a service provider has to implement or allocate services into his network a long process of checking available resources within the monolithic structure will take place. In case the available resources do not meet the requirements to allocate the required services, the service provider has to ask the network infrastructure provider to provide for new resources.

If the required services are temporary—such as in case of peak services—the new resources will become useless when the services are no more required. Moreover, if the service provider wishes to reduce certain services, the allocated resources cannot be reduced correspondingly.

Cloud computing has emerged recently as optimization of the closed resource systems. A cloud is defined as a set of remote resources (e.g., processing, storage, or other resources) available through a network that can serve at least some traditional datacenter functions for an enterprise.

US 2012/331113 discloses a cloud computing platform configured to allocate resources to a software application such that execution of the software application by the cloud computing platform meets one or more performance levels specified in a service level agreement. Performance levels of a service level agreement may include parameters relating to execution of the software application, such as an execution time for an operation performed by the software application under a specified load to be imposed on the cloud computing platform by the software application. During execution of the software application, the cloud computing platform may monitor performance metrics of the software application and compare values for the performance metrics to performance levels and conditions of the service level agreement. The cloud computing platform can then manage the allocation of resources to the software application such that execution performance of the software application is within the agreed performance levels of the service level agreement when the conditions are met. For example, the cloud computing platform may allocate additional resources when execution of the software application is not within the performance levels or de-allocate resources when the software application allocated more resources than necessary for execution to meet the performance levels.

US 2008/80552 discloses a system for dynamically allocating resources (hardware and/or software) supported by a third party service provider. An interface component can receive a request from a client device. Further, a dynamic allocation component can apportion resources (e.g. hardware resources) supported by the third party service provider to process and respond to the request based at least in part upon subscription data. Hardware resources can be allocated dynamically, for example, based upon subscription related data or as a function of time based upon user need.

WO 2012/162167 discloses a cloud migration system providing capacity management and disaster recovery by detecting peak load conditions and automatically moving computing to another computing resource (and back) and by providing computing across two or more clouds and moving completely to one in the case of a disaster at one site. This allows enterprises to plan for local resources for a sustained level of load and to leverage cloud-based resources for peak or other unusual loads. The cloud migration system monitors loads within a datacenter and detects a threshold that indicates that the current load is nearing the datacenter capacity. Upon detecting that the threshold will be reached, the cloud migration system facilitates an orderly move of at least some datacenter load to another datacenter or cloud-based resources. The system can also be used as a disaster recovery architecture at a datacenter/network level to manage fast workload transition in case of disaster. If a datacenter resource permanently fails, the system can quickly and efficiently migrate additional load to the cloud or other resources. Thus, the cloud migration system allows enterprises to build smaller and more efficient datacenters that leverage other resources for extra loads.

### SUMMARY OF THE INVENTION

Against this background, a network entity for managing resource allocation in a mobile telecommunication network is provided herewith.

It has been found that it is convenient to have a first interface configured to enable the network entity to communicate with one or more cloud managing entities, each managing respective remote resources, and a second interface configured to enable the network entity to control operations between one or more network managing entities and the one or more cloud managing entities, wherein each of the one or more network managing entities manages respective network elements.

Therefore, in a first aspect it is provided a network entity for managing resource allocation in a mobile telecommunication network, said network entity comprising a first interface configured to enable said network entity to communicate with one or more cloud managing entities, wherein each of said one or more cloud managing entities manages respective remote resources, and a second interface configured to enable said network entity to control operations between one or more network managing entities and said one or more cloud managing entities, wherein each of said one or more network managing entities manages respective network elements, wherein said network entity is configured to perform a first function, said first function including exchanging information with said one or more cloud managing entities over said first interface and controlling the operations between said one or more network managing entities and said one or more cloud managing entities based on said information, said information comprising a status of at least one of the respective remote resources managed by said one or more cloud managing entities.

Preferably, said network entity is further configured to determine whether at least one of the network elements requires use of remote resources and/or modification of use of remote resources and/or management of allocation of remote resources for use in disaster recovery.

According to one embodiment, the determination is based on an indication, received from one or more network managing entities over said second interface, that at least one of the respective network elements requires use of remote resources.

Alternatively, the determination is performed autonomously by the network entity, preferably based on a prediction of future use of remote resources by at least one of the network elements.

Preferably, said information enable said network entity to determine whether the at least one of the respective remote resources are available for use by at least one of the network elements.

Advantageously, said operation includes at least one of triggering deployment of at least one of the remote resources for use by at least one of the network elements, modifying existing deployment of at least one of the remote resources for use by at least one of the network elements, changing current or future allocation of remote resources for use by at least one of the network elements.

Preferably, said information enable said network entity to determine and/or verify a disaster recovery plan for at least one of the remote resources.

Preferably, said network entity is configured to allocate, for each datacenter of a plurality of datacenters, a set of disaster recovery remote resources to be used in case of at least partial failure of an application, and store, for each datacenter of said plurality of datacenters, information about disaster recovery remote resources allocated for the applications hosted by each other datacenter of said plurality of datacenters.

Preferably, for each application of a plurality of applications, said allocation of a set of disaster recovery remote resources is based on availability of remote resources not previously allocated for disaster recovery.

Preferably, in case of unavailability of remote resources not previously allocated for disaster recovery of other applications, said allocation is further based on availability of remote resources previously allocated for disaster recovery of other applications of said plurality of applications.

Preferably, for each application of a plurality of applications, said modification of a set of disaster recovery remote resources is based on a comparison of remote resources to be used for said application with actual disaster recovery resources allocated for said application.

Preferably, said network entity is further configured to perform a second function, said second function allowing the network entity to manage service templates associated to one or more applications composing a service, said network entity comprising a first network entity configured to perform said first function and a second network entity configured to perform said second function.

Preferably, said second network entity is configured to perform said second function on the basis of one or more application instances available through respective one or more first network entities.

Preferably, the first sub-entity operates as a domain controller. Preferably, the second sub-entity operates a service controller.

In a second aspect there is provided a system for managing resource allocation in a mobile telecommunication network, said system comprising a network entity for managing resource allocation, one or more cloud managing entities, each of said one or more cloud managing entities managing respective remote resources, one or more network managing entities each of said one or more network managing entities managing respective network elements, wherein network entity comprises a first interface configured to enable said network entity to communicate with said one or more cloud managing entities, and a second interface configured to enable said network entity to control operations between said one or more network managing entities and said one or more cloud managing entities, wherein said network entity is configured to perform a first function, said first function including exchanging information with said one or more cloud managing entities over said first interface and controlling the operations between said one or more network managing entities and said one or more cloud managing entities based on said information, said information comprising a status of at least one of the respective remote resources managed by said one or more cloud managing entities.

### BRIEF DESCRIPTION OF THE DRAWINGS

The present invention will now be described in more detail hereinafter with reference to the accompanying drawings, in which some embodiments of the invention are shown. Drawings illustrating the embodiments are schematic representations.

FIG. 1 is a schematic view of a system for managing resource allocation in a mobile telecommunication network comprising a network entity according to one embodiment of the present invention,

FIG. 2 is a further schematic view of the system of FIG. 1,

FIG. 3 is a schematic view of the system of FIG. 1 according to a different embodiment,

FIG. 4 is a flow chart with the steps for deploying remote resources in the system of FIG. 1,

FIGS. 5 and 6 show the messages exchanged between the entities of the system of FIG. 1 for deployment of remote resources according to FIG. 4,

FIG. 7 is a flow chart with the steps for modifying deployment (scale in) of remote resources in the system of FIG. 1,

FIGS. 8-10 show the messages exchanged between the entities of the system of FIG. 1 for modifying deployment of remote resources according to FIG. 7,

FIG. 11 is a flow chart with the steps for modifying deployment (scale out) of remote resources in the system of FIG. 1,

FIGS. 12-14 show the messages exchanged between the entities of the system of FIG. 1 for modifying deployment of remote resources according to FIG. 11,

FIG. 15-17 show flow charts with the steps for changing allocation of deployed remote resources in the system of FIG. 1,

FIG. 18 is a flow chart with the steps for estimating the capacity expansion of a datacenter in the system of FIG. 1.

### DETAILED DESCRIPTION

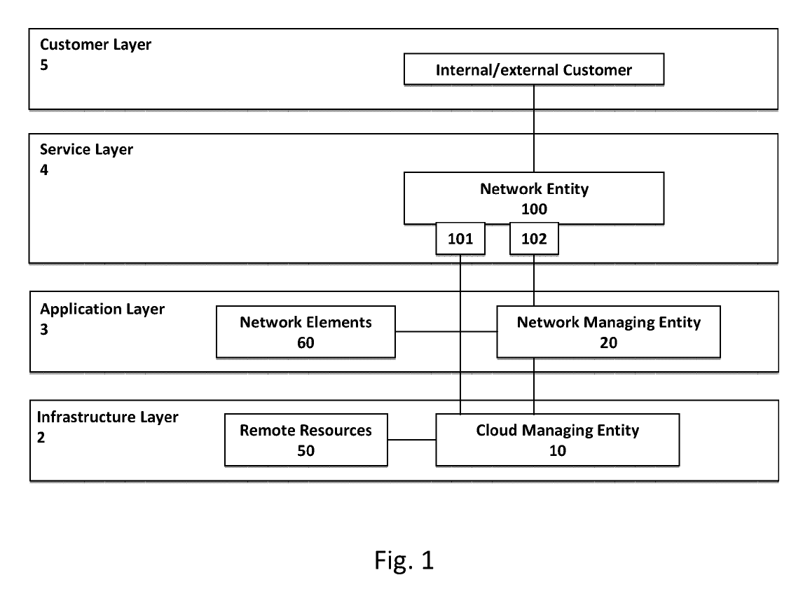

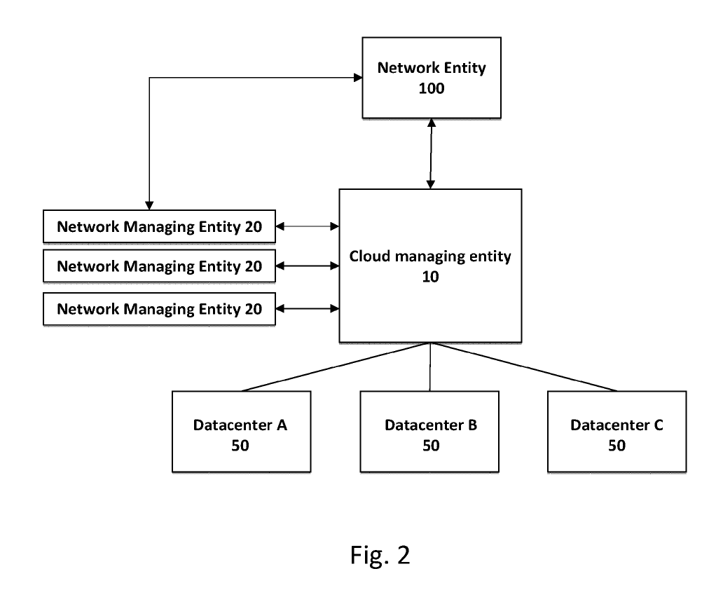

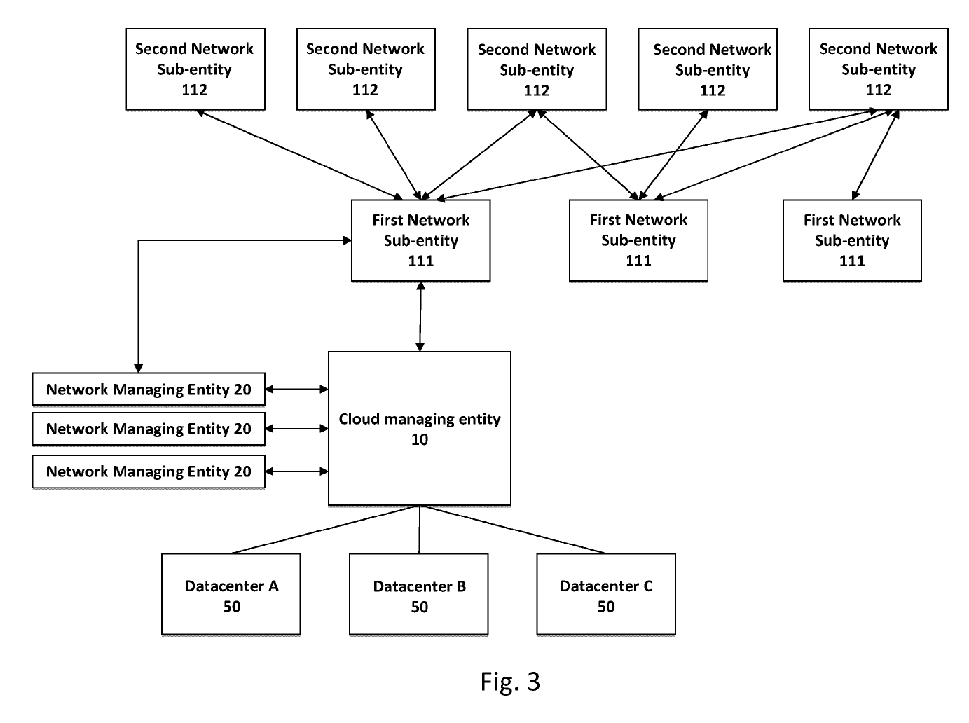

FIGS. 1 and 2 shows a system 1 for managing resource allocation in a mobile telecommunication network.

The system 1 comprises a network entity 100 for managing resource allocation in a mobile telecommunication network, one or more cloud managing entities 10 and one or more network managing entities 20.

Each of the cloud managing entities 10 is configured to manage respective remote resources 50.

According to a preferred embodiment, the remote resources 50 comprise cloud resources.

Each of the network managing entities 20 is configured to manage respective network elements 60. Each network element 60 may be hosted in one or more remote resources 50.

One or more telecommunication network applications are loaded and run on a respective network element 60 to perform a network service requested by a customer.

Hereinafter the telecommunication network application will be referred to as application and the network service as service.

A service is instantiated by one or more application instances loaded and running on a respective network element 60.

The set of application instances necessary to instantiate a service are associated to respective service templates.

Preferably, a service template comprises the set of application instances necessary to instantiate a service and the configuration settings for each application instance.

According to one embodiment, the system 1 comprises an infrastructure layer 2, an application layer 3, a service layer 4 and a customer layer 5 (FIG. 2).

The infrastructure layer 2 includes:
a hardware layer, which provides computing power, storage and connectivity and therefore it is composed of hardware, storage and network switching components,
a transport layer based on switches connected to a central management system,
a virtualization layer, which includes operative systems allowing to dynamically allocate the remote resources 50 to one or more applications (this layer includes the cloud managing entities 10),
infrastructure management managing the virtualized resources and allocating the resources to the applications.

The application layer 3 includes:
application software instances and software modules with respective operating systems,
application management including the network managing entities 20 which control the applications and cooperate with the cloud managing entities 10 to request the resources needed to install the application instances and to control the resources availability and use.

The service layer 4 includes the network entity 100 and provides the management of requested services, guiding the applications installation and configuration and the capacity management according to the received requests.

The customer layer 5 includes customers requiring resources for one or more applications and corresponding services.

The network entity 100 comprises a first interface 101 and a second interface 102.

The first interface 101 is configured to enable the network entity 100 to communicate with one or more cloud managing entities 10.

The second interface 102 is configured to enable the network entity 100 to control operations between one or more network managing entities 20 and the one or more cloud managing entities 10.

In particular, the first interface 101 allows the network entity 100 to exchange information with the cloud managing entities 10. The information include data representative of a status of the respective remote resources 50 managed by the cloud managing entities 10.

According to one embodiment, the information enables the network entity 100 to determine whether the respective remote resources 50 are available for use by the network elements 60.

The network entity 100 is configured to perform a first function. This first function includes controlling the operations between the network managing entities 20 and the cloud managing entities 10 based on the information and exchanging information with the cloud managing entities 10. This first function is referred to as domain controller function. A domain comprises the plurality of cloud managing entities 10 configured to manage a set of remote resources 50 and the plurality of network managing entities 20 configured to manage the network elements 60 associated with the set of remote resources 50.

In particular, the first function allows the network entity 100 to manage the capacity plan of each application and datacenter, disaster recovery plans, scale in and scale out as it will be described in detail thereafter.

Preferably, the operations controlled by the network entity 100 comprise at least one of triggering deployment of the remote resources for use by a network element, modifying existing deployment of remote resources for use by a network element, changing allocation of deployed remote resources for use by a network element.

According to one embodiment, each cloud managing entity 10 interfaces the remote resources 50 with one or more network managing entities 20 to provide the requested remote resources 50 needed to install the application instances in the network elements 60.

In particular, the cloud managing entities 10 are configured to:
allocate virtual machines on available cloud resources 50,
dynamically allocate virtual machines to optimize the use of cloud resources 50,
provide cloud resources 50 to allow the network managing entities 20 to install the requested application instances.

The application layer 3 comprises a plurality of applications and one network managing entity 20 for each application.

Preferably, each application is associated to a plurality of application templates, each application template defining a corresponding application size.

An application template defines the architecture of the application and, preferably, comprises the following data:
types of virtual machines composing the application, including CPU, RAM and storage,
number of virtual machines,
redundancy (this will be described in detail hereinafter with reference to the disaster recovery plans),
IP connectivity and IP interfaces,
load balancing requirements,
storage requirements,
capacity,
disaster recovery model for the application,
application technical and geographical requirements.

Each network managing entity 20 is therefore configured to manage the templates of the applications, implement the applications in the cloud resources 50 and monitoring the resources 50 allocated to the applications.

According to one embodiment, the network entity 100 is configured to manage the applications, the cloud resources 50, the capacity of the network and the deployment of the applications.

The network entity 100 is configured to receive information on the virtual machines composing each application and the datacenter on which they are hosted and run.

According to one embodiment, the network entity 100 is further configured to perform a second function.

The second function allows the network entity 100 to manage the service templates which are associated to the application instances needed to perform a service. This second function is referred to as service controller function.

According to a first embodiment, the first and second functions are performed by a single network entity 100. This is typical for service providers offering telecommunication network in limited geographical areas.

According to a second embodiment, the first function is associated to a first network sub-entity, indicated with 111, and the second function is associated to a second network sub-entity, indicated with 112. The first network sub-entity 111 is referred to as domain controller and the second network sub-entity 112 is referred to as service controller.

In particular, the system 1 may comprise a plurality of second network sub-entities 112. Each second network sub-entity 112 is configured to manage a set of services and communicate with one or more first network sub-entities 111, specifically with the first network entity or the first network sub-entities 111 in which the applications composing the set of services need to be instantiated.

In case the instantiation of a service requires applications, i.e. corresponding remote resources 50, of a specific domain, the second network sub-entity 112 communicates with the first network sub-entity 111 of that specific domain.

In case the instantiation of a service requires applications, i.e. corresponding remote resources 50, of a different domains. the second network sub-entity 112 communicates with the first network sub-entities 111 of the domains managing the cloud resources 50 necessary to the instantiate the required service. In this case, the second network sub-entity 112 is configured to communicate with the first network sub-entities 111 to obtain information about the availability of remote resources 50.

### Domain Controller

In a specific domain, the network entity 100—in case the service controller and domain controller functions are performed by a single network entity 100—or the first network sub-entity 111—in case in case the domain controller and service controller functions are performed respectively by a first and second network sub-entities 111,112—cooperates with one or more cloud managing entities 10.

Hereinafter, reference will be made to the network entity 100.

In this embodiment, the information exchanged between the network entity 100 and the cloud managing entities 10 comprises at least one of the following data: the total number of remote resources, the number of available resources and the maximum deployable size of virtual machines. Preferably, each data defines at least one of storage size in Gb, CPU rate in GHZ and RAM size in Gb.

According to one embodiment, the network entity 100 obtains the data representative of a status of the respective remote resources 50 managed by the cloud managing entities 10 by performing a resources information request process.

Three different operations are available for exchanging information between the network entity 100 and each cloud managing entity 10 and performing the resources information request process. These operations comprise a periodic update operation, a request update operation and push notification operation. In all operations, preferably two messages are exchanged: a Resources Status Update Request message and a Resources Status Notification message.

The Resources Status Update Request message is sent by the network entity 100 to a cloud managing entity 10 to request information on the updated resources data stored in the cloud managing entity 10.

Preferably, the Resources Status Notification message includes at least one of the following data for each datacenter:
datacenter identification which univocally identifies the datacenter,
datacenter country which identifies the country of the datacenter,
application countries which indicates which countries are allowed to upload applications in the datacenter,
the total number of remote resources, which indicates the total resources of the datacenter,
the number of available resources of the datacenter,
the maximum deployable size of virtual machines which indicates the maximum values that the datacenter can accept for a single virtual machine.

As stated above, the total number of remote resources, the number of available resources of the datacenter and the maximum deployable size of virtual machines are preferably provided in terms of storage size in Gb, CPU rate in GHZ and RAM size in Gb.

It is worthwhile to note that an update of the resources status may be necessary even when it is not requested by the network entity 100. In this embodiment, the cloud managing entity 10 sends a Resource Availability Change message or a New Resources Status Notification message.

In particular, the Resource Availability Change message is sent by a cloud managing entity 10 to the network entity 100 when a change of the available resources occurs in a datacenter, for example due to new hardware installation, maintenance activity or failure.

The New Resources Status Notification message is sent by a cloud managing entity 10 to the network entity 100 to provide information on the status on new resources.

According to the periodic update operation, the network entity 100 comprises a timer 105 having a time-lapse T. After triggering the timer 105, the network entity 100 waits the timer 105 to reach the time-lapse T.

Then the network entity 100 sends a Resources Status Update Request message to the cloud managing entity 10. Upon receiving the Resources Status Update Request message, the cloud managing entity 10 checks the status of the resources and sends a Resources Status Notification message to the network entity 10. Upon receiving the Resources Status Notification message, the network entity 100 resets the timer 105.

According to the request update operation, the network entity 100 checks when one of the network managing entities 20 sends a scale request or new deployment request. As it will be described in more detail hereinafter, a scale request is used to modify an existing deployment of remote resources for use by a network element or to change allocation of deployed remote resources for use by a network element. When this occurs, the network entity 100 sends a Resources Status Update Request message to the cloud managing entity 10. Upon receiving the Resources Status Update Request message, the cloud managing entity 10 checks the status of the resources and sends a Resources Status Notification message to the network entity 100. Upon receiving the Resources Status Notification message, the network entity 100 resets the timer 105.

According to the push notification operation, the cloud managing entity 10 monitors a set of remote resources. When a change of the available resources occurs, the cloud managing entity 10 sends a Resource Availability Change message to the network entity 10. Upon receiving the Resources Availability Change message. the network entity 100 resets the timer 105.

Preferably, each cloud managing entity 10 is configured to send a message to the network entity 100 when a datacenter is no longer available. In this case, the cloud managing entity 10 sends a Datacenter Unreachable message to the network entity 100. Preferably, this message includes the following data:
datacenter identification: this field is necessary in order to univocally identifies the datacenter that is no longer reachable,
alarm identification: a field used by the network entity 100 as alarm identifier,

Moreover, each cloud managing entity 10 is configured to send to the network entity 100 a message including the applications which run in the remote resources 50 it manages. This message, as the Resources Status Notification message, may be sent periodically. This message is sent when there are applications deployed without a related network managing entity 20. This message allows to update the network entity 100 about the applications running in the network. This message includes, for each datacenter, the following information:
datacenter identification: this field is necessary in order to univocally identify the datacenter,
application instances name: a field used by the network entity 100 in order to univocally identify each application instance,
application instances allocated resources: a field used to inform the network entity 100 about the amount of resources that the cloud managing entity 20 has allocated for the application instance,
application instance vendor which is an identifier of the owner of the application.

As stated above, each network entity 100 is also configured to exchange information with the one or more network managing entities 20 over the second interface 21. The information includes, for each application instance deployed, the following data:
application templates,
application instances managed by the network managing entity 20 and deployed.

Based on the information, the network entity 100 is able to estimate the capacity expansion for each application instance.

The information is exchanged between the network entity 100 and each network managing entity 20 based on the periodic update operation, the request update operation and the push notification operation.

According to the periodic update operation, the network managing entity 20 sends an Application Instances Workload Update Notification message to the network entity 100 to inform the network entity 100 about the current workload of the running application instances. The Application Instances Workload Update Notification message includes:
network managing entity identification to univocally identify a new network managing entity,
application instance identification which together with the network managing entity identification univocally identifies a specific application instance,
application instance workload average value, expressed as a percentage of the maximum capacity of the current application template that the application instance has experienced in a considered time range.

According to the request update operation, the network entity 100 sends an Application Instances Workload Update Request message to the network managing entity 20. In response, the network managing entity 20 sends to the network entity 100 an Application Instances Workload Update Notification message.

Furthermore, according to the request update operation, the network managing entity 20 sends an Application Templates Information to the network entity 100. This message is sent when the network managing entity 20 is instantiated for the first time and every time an application template is modified. This message may include:
total virtual CPU needed, both in number of CPU and in GHz;
total memory needed;
total storage needed;
total bandwidth needed;
capacity figure;
disaster recovery model.

According to one embodiment, the network entity 100 is configured to store, for each application instance, a workload data, preferably as a percentage of the maximum capacity available to the application according to the corresponding application template.

Preferably, a priority value is assigned to each application instance. This priority value is evaluated in case of resource constraints in order to decide which application may obtain additional resources first.

It should be noted that each datacenter allocates and maintains available an amount of resources to be used in case of hardware failure in the datacenter. These resources will be referred to as spare resources.

In addition, each datacenter allocates and maintains available an amount of resources to be used in case of hardware failure of another datacenter. These resources are referred to as disaster recovery resources or resources.

In case of failure of an application, a predefined disaster recovery plan for the failed applications is performed on the basis of a predefined disaster recovery model. As it will be described in detail hereinafter, the actions to be performed depend on the disaster recovery model of the failed applications.

Therefore, advantageously, for each datacenter, the network entity 100 is configured to store the amount of resources allocated for disaster recovery purposes for the applications hosted by each other datacenter.

In addition, the network entity 100 is configured to store information representative of the physical resources of each datacenter and the application instances hosted in the datacenter with the corresponding template information. As it will be described in detail hereinafter, these information are used for the capacity planning of the datacenter.

Preferably, the network entity 100 has an internal database and is configured to store in the internal database the following information.

For each datacenter:
the spare resources in terms of memory, CPU and storage,
the maximum supported size of virtual machines in terms of maximum number of CPU and maximum amount of RAM,
the list of the application instances hosted in the datacenter, and for each instance the tenant providing the application instance and the application template running,
the datacenter country,
the nationality of applications which can be hosted by the datacenter,
the total amount of disaster recovery resources allocated for each application in terms of memory, CPU and storage.

For each application, the templates information including:
nominal application capacity;
total virtual CPU needed, both in number of CPU and in GHz;
total memory needed
total storage needed;
total bandwidth needed;
disaster recovery model.

For each application instance, the following information are provided:
the datacenter hosting the application instance,
the application template used,
resources usage as percentage of maximum available resources;
service priority index.
secondary datacenter to be used in case of failure.

### Service Controller

As stated above, the domain controller function and the service controller function of the network entity 100 may be associated respectively to a first network sub-entity 111 and a second network sub-entity 112.

Preferably, each second network sub-entity 112 is configured to communicate with each first network sub-entity 111 where applications have to be installed. In particular, the second network sub-entity 112 is configured to send, to each first network sub-entity 111 where applications have to be installed, a message including the indication of the application template to be deployed. For example, the application template may define a small, medium or large size application.

According to one embodiment, each second network sub-entity 112 is configured to receive from each first network sub-entity 111 a message with the list of the managed datacenters and a message with the list of all applications templates.

Therefore, each second network sub-entity 112 is able to set up a service template on the basis of one or more application instances available through one or more first network sub-entities 111.

In particular, the second network sub-entity 112 is configured to receive from each first network sub-entity 111 the following information:
the application templates stored in the second network sub-entity 112,
the datacenter data stored in the second network sub-entity 112 with the available spare resources and the evolution of the space resources estimated by the second network sub-entity 112 (this will be described in detail hereinafter).

Based on the above information, the second network sub-entity 112 requests, from all the interfaced first network sub-entities 111, the application instances required to implement a requested service according to the service templates.

Each first network sub-entity 111 sends to the second network sub-entity 112 a positive or negative message.

The second network sub-entity 112 receives, collects and process all the messages sent by the interfaced first network sub-entities 111 to implement the requested service. If the service is implemented, the second network sub-entity 112 sends a confirmation message to all the interfaced first network sub-entities 111 to proceed with the instantiation of the needed application instances.

Preferably, the second network sub-entity 112 has an internal database and is configured to store in the database the following information

For each datacenter in each domain:
the space resources in terms of memory, CPU and storage,
the maximum supported size of virtual machines in terms of maximum number of CPU and maximum amount of RAM,
the datacenter country,
the nationality of applications which can be hosted by the datacenter,

For each application, the following templates information:
nominal application capacity;
total virtual CPU needed, both in number of CPU and in GHz;
total memory needed
total storage needed;
total bandwidth needed;
disaster recovery model.

For each application instance:
the datacenter hosting the application instance,
the application template used,
resources usage as percentage of maximum available resources;
service priority index.
secondary datacenter to be used in case of failure.

Hereinafter, the above cited operations controlled by the network entity 100 are disclosed.

### Triggering Deployment of the Remote Resources for Use by a Network Element—New Deployment

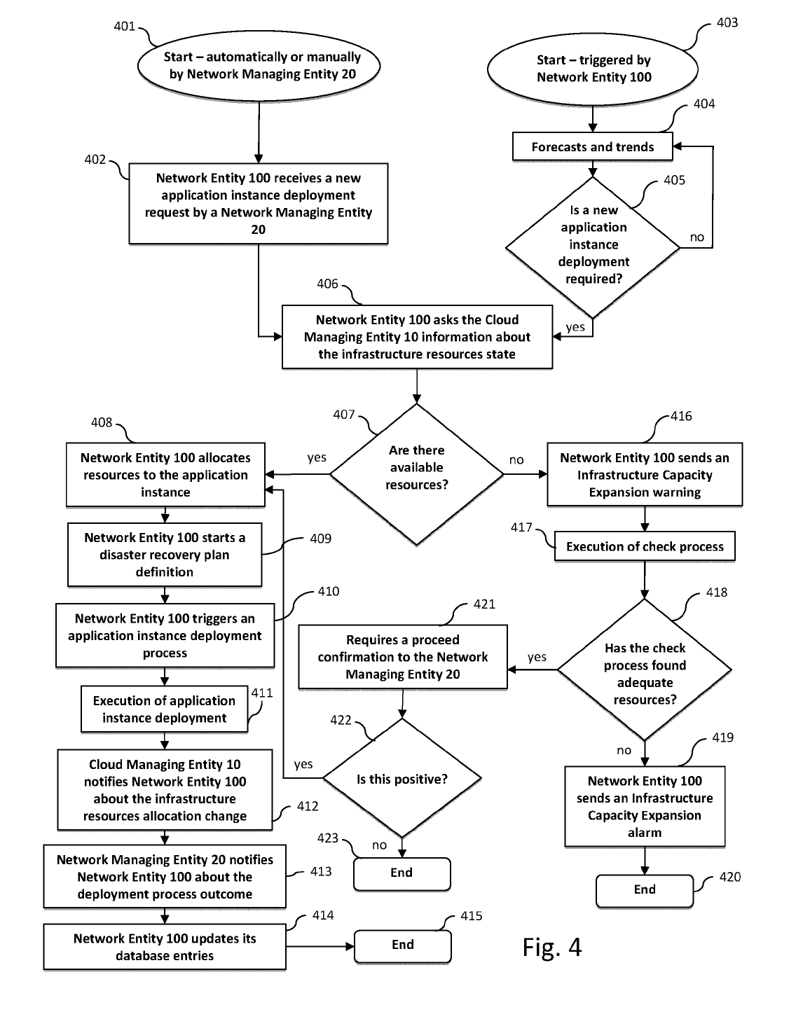

A deployment of remote resources is performed to deploy an instance of an application (FIG. 4).

When a new application instance is requested to be deployed, the network entity 100 checks the status of the remote resources 50.

If resources are available, a set of resources are allocated to the requested new application instance, a disaster recovery plan is created for the new application instance and the application instance is deployed.

If resources are not available, a check process is performed to find the required resources by managing allocated resources.

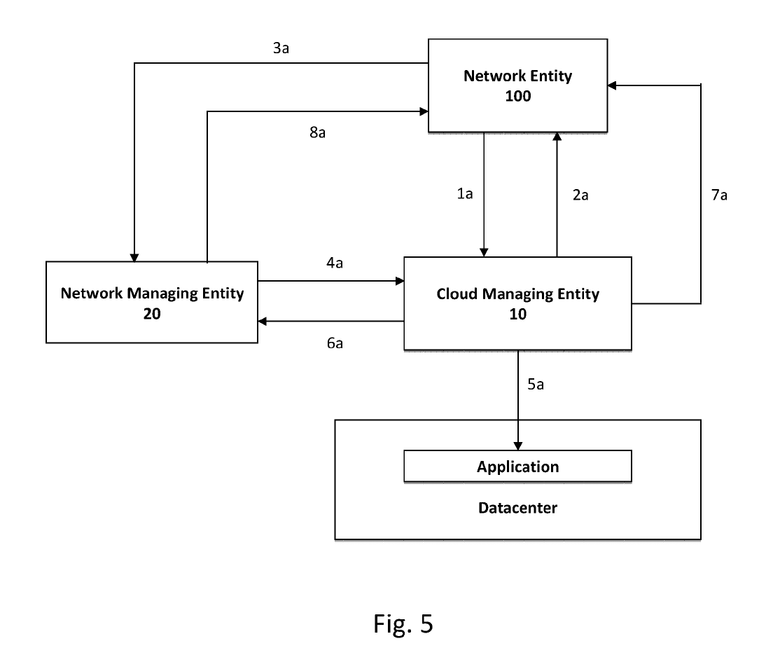

According to a first embodiment (FIG. 5), the deployment of an instance of an application is triggered by the network entity 100 based on application workload data.

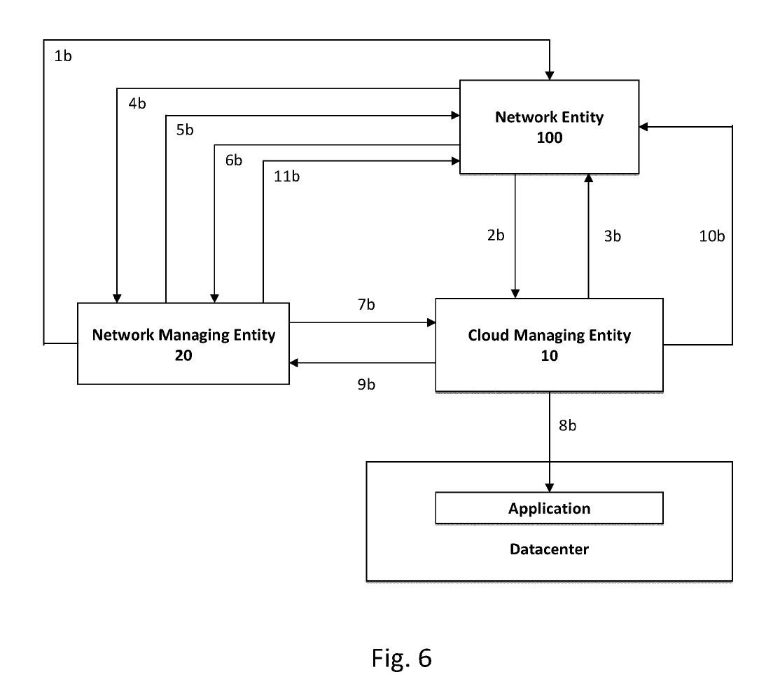

According to a second embodiment (FIG. 6), the deployment of an instance of an application is requested by an operator through a network managing entity 20.

In both embodiments the network entity 100 sends a Resource Status Update Request message to a cloud managing entity 10 to receive an Resources Status Notification message.

In case of sufficient resources availability, the network entity 100 allocates the required resources to the new application instance as indicated by the application template. The allocated resources are then subtracted from the available capacity value. Afterwards, the network entity 100 performs a disaster recovery plan creation process (described hereinafter) and the application instance deployment. Once the deployment is completed, the network entity 100 receives from the cloud managing entity 10 a message confirming the resources allocation and from the network managing entity 20 a message about the deployment process outcome.

In case there are no sufficient resources to satisfy the request, the network entity 100 triggers an Infrastructure Capacity Expansion warning. A check process is performed in order to find the required resources for the deployment by moving resources left apart for disaster recovery purposes or by triggering a scale in process (described hereinafter) to other application instances.

If this check process does not allow to find available resources, the network entity 100 triggers an Infrastructure Capacity Expansion alarm.

According to the first embodiment (FIG. 5), the deployment of an instance of an application comprises the following steps:

1a) the network entity 100 sends a Resources Status Update Request message to the cloud managing entity 10,

2a) in response, the cloud managing entity 10 sends a Resources Status Notification message to the network entity 100,

3a) the network entity 100 verifies the availability of the resources required by the application template and sends to the related network managing entity 20 an Application Instance Deployment message to trigger the new deployment process.

Preferably, this message includes the following data:
the network managing entity identification,
the application instance identification,
the application template size of the application instance to deploy,
the identification of the datacenter where the instance will run,

4a) the network managing entity 20 sends a New Deployment Request message to the cloud managing entity 10 to deploy the requested application instance,

5a) the cloud managing entity 10 deploys the application instance requested,

6a) the cloud managing entity 10 sends a New Deployment Confirmation message to the network managing entity 20,

7a) the cloud managing entity 10 sends a New Resources Status Notification message to the network entity 100 to notify the network entity 100 about an infrastructure resources allocation change,

8a) the network managing entity 20 sends an Application Instance Deployment Notification message to the network entity 100 to informs about the application instance deployment outcome.

According to the second embodiment (FIG. 6), the deployment of an instance of an application comprises the following steps:

1b) a network managing entity 20 sends an Application Instance Deployment Request message to the network entity 100 to trigger a process new deployment process.

Preferably, this message includes the following data:
the network managing entity identification,
the application instance identification,
the application template size of the application instance to deploy,
the identification of the datacenter where the instance will run,

2b) the network entity 100 sends a Resources Status Update Request message to the cloud managing entity 10,

3b) in response, the cloud managing entity 10 sends a Resources Status Notification message to the network entity 100,

4b) the network entity 100 sends a Conditioned Response message to the network managing entity 20 if the value of the Resources Status Notification message does not allow to proceed with the application instantiation. Preferably, this message includes the following data:
the network managing entity identification,
the application instance identification,
the application template size of the application instance to deploy,
the identification of the datacenter where the instance will run,
the request outcome; in particular, the request outcome may have the following values:
   provisionally rejected, if there are not sufficient resources and the deployment can be performed by allocating resources dedicated to disaster recovery plan or by executing application rapid-elasticity;
   rejected, if there are not sufficient resources even by allocating resources dedicated to disaster recovery plan or by executing application rapid-elasticity;

5b) if the request outcome value is provisionally rejected, the network managing entity 20 sends an Application Instance Deployment Confirmation message to the network entity 100. Preferably, this message includes:
the network managing entity identification,
the application instance identification,
the application template size of the application instance to deploy,
the identification of the datacenter where the instance will run,
confirmation which can have the following values: proceed or not proceed

6b) the network entity 100 verifies the availability of the resources required by the application template and sends to the related network managing entity 20 an Application Instance Deployment message to trigger the new deployment process.

Preferably, this message includes the following data:
the network managing entity identification,
the application instance identification,
the application template size of the application instance to deploy,
the identification of the datacenter where the instance will run,

7b) the network managing entity 20 sends a New Deployment Request message to the cloud managing entity 10 to deploy the requested application instance,

8b) the cloud managing entity 10 deploys the application instance requested,

9b) the cloud managing entity 10 sends a New Deployment Confirmation message to the network managing entity 20,

10b) the cloud managing entity 10 sends a New Resources Status Notification message to the network entity 100 to notify the network entity 100 about an infrastructure resources allocation change,

11b) the network managing entity 20 sends an Application Instance Deployment Notification message to the network entity 100 to inform about the application instance deployment outcome.

Modifying Existing Deployment of Remote Resources for Use by a Network Element—Scale in/Scale Out.

A scale in process is performed whenever the application template of a deployed application instance changes to an application template with lower size.

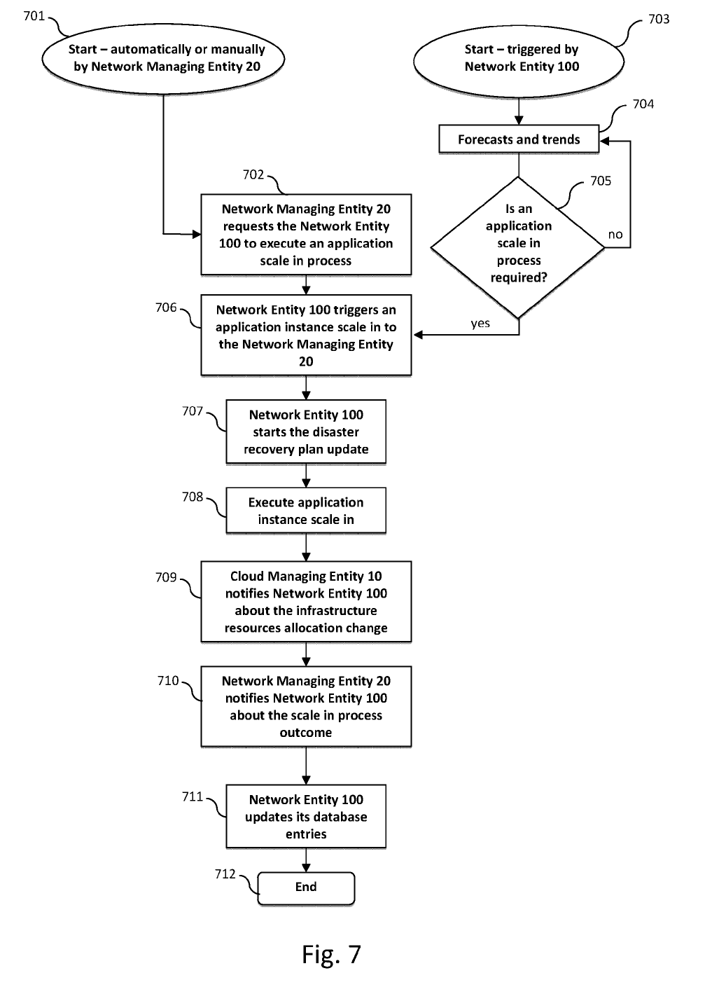

In the scale in process, the network entity 100, autonomously or triggered by the network managing entity 20, starts an application instance scale in a network managing entity 20 (FIG. 7).

The network entity 100 then updates the disaster recovery plan, performs the application instance scale in request. The cloud managing entity 10 notifies the network managing entity 20 in case of process success and informs the network entity 100 of the occurred change of resources availability. The network managing entity 20 notifies the network entity 100 about the scale in process success and the network entity 100 updates a value on an internal database.

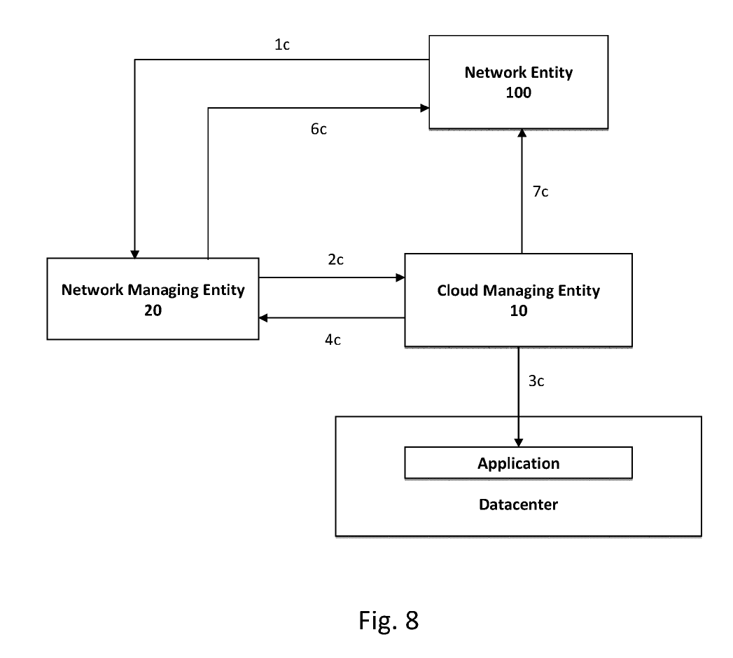

According to a first embodiment (FIG. 8), the scale in process is triggered by the network entity 100.

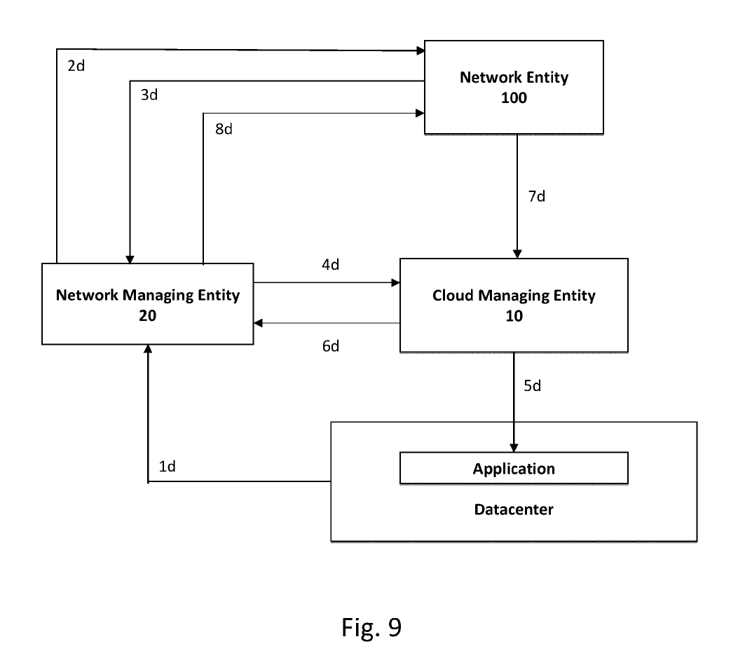

According to a second embodiment (FIG. 9), the scale in process is requested automatically by a network managing entity 20.

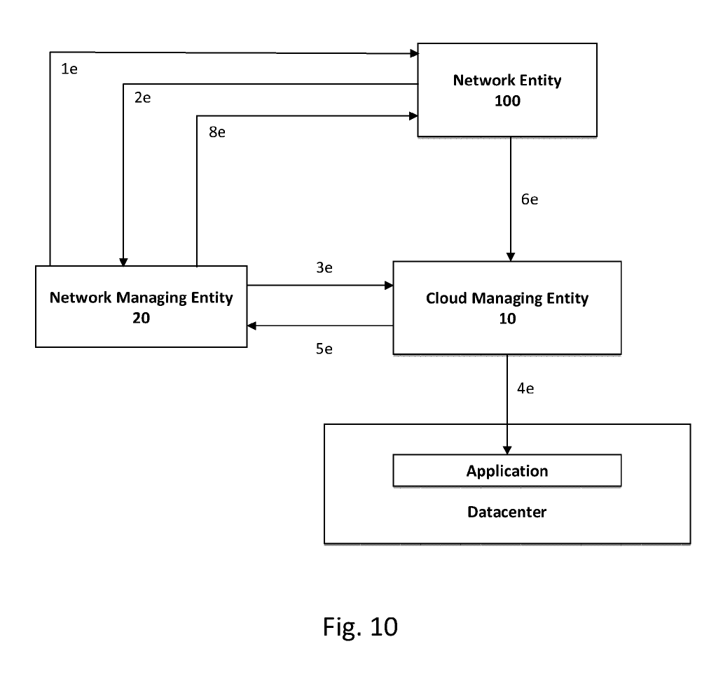

According to a third embodiment (FIG. 10), the scale in process is requested by an operator through a network managing entity 20.

According to the first embodiment (FIG. 8), the scale in process comprises the following steps:

1c) the network entity 100 sends an Application Instance Scale In message to the network managing entity 20 in order to trigger an application instance scale in process. Preferably, this message includes:
the network managing entity identification,
the application instance identification,
the application template size of the new application instance to deploy,

2c) the network managing entity 20 sends a Scale In Request message to the cloud managing entity 10 to request the scale in;

3c) the cloud managing entity 10 performs the requested scale in,

4c) the cloud managing entity 10 sends a Scale In Confirmation message to the network managing entity 20 to confirm the scale in process outcome;

5c) the network managing entity 20 sends an Application Instance Scale In Notification message to the network entity 100 to notify about the scale in process success. Preferably, this message includes:
the network managing entity identification,
the application instance identification,
the application template size of the new application instance to deploy.

According to the second embodiment (FIG. 9), the scale in process comprises the following steps:

1d) an application instance running on a datacenter sends an Application Instance Monitoring message to a network managing entity 20,

2d) the network managing entity 20 sends an Application Instance Scale In Request message to the network entity 100 to trigger an application instance scale in process. Preferably, this message includes:
the network managing entity identification,
the application instance identification,
the application template size of the new application instance to deploy,

3d) in response, the network entity 100 sends an Application Instance Scale In message to the network managing entity 20 in order to trigger an application instance scale in process. Preferably, this message includes:
the network managing entity identification,
the application instance identification,
the application template size of the new application instance to deploy,

4d) the network managing entity 20 sends a Scale In Request message to the cloud managing entity 10 to request the scale in;

5d) the cloud managing entity 10 performs the requested scale in,

6d) the cloud managing entity 10 sends a Scale In Confirmation message to the network managing entity 20 to confirm the scale in process outcome;

7d) the network managing entity 20 sends an Application Instance Scale In Notification message to the network entity 100 to notify about the scale in process success. Preferably, this message includes:
the network managing entity identification,
the application instance identification,
the application template size of the new application instance to deploy.

According to the third embodiment (FIG. 10), the scale in process comprises the following steps:

1e) the network managing entity 20 sends an Application Instance Scale In Request message to the network entity 100 to trigger an application instance scale in process.

Preferably, this message includes:
the network managing entity identification,
the application instance identification,
the application template size of the new application instance to deploy,

2e) in response, the network entity 100 sends an Application Instance Scale In message to the network managing entity 20 in order to trigger an application instance scale in process. Preferably, this message includes:
the network managing entity identification,
the application instance identification,
the application template size of the new application instance to deploy,

3e) the network managing entity 20 sends a Scale In Request message to the cloud managing entity 10 to request the scale in;

4e) the cloud managing entity 10 performs the requested scale in,

5e) the cloud managing entity 10 sends a Scale In Confirmation message to the network managing entity 20 to confirm the scale in process outcome;

6e) the network managing entity 20 sends an Application Instance Scale In Notification message to the network entity 100 to notify about the scale in process success. Preferably, this message includes:
the network managing entity identification,
the application instance identification,
the application template size of the new application instance to deploy.

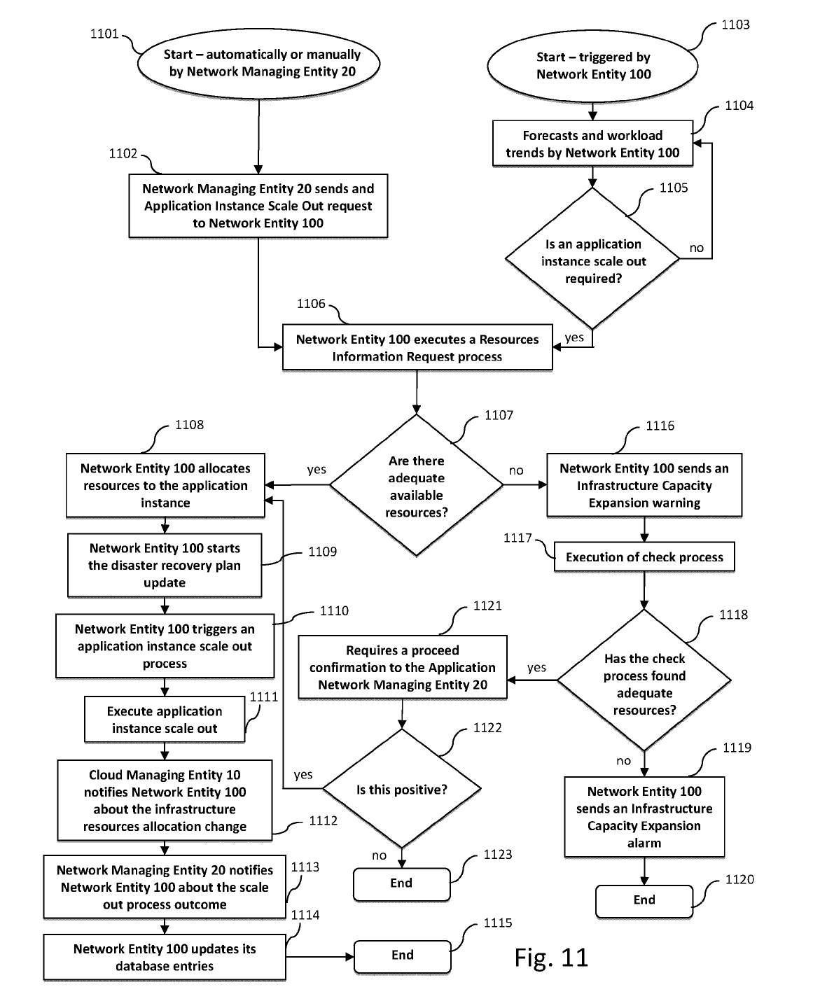

A scale out process is performed whenever the application template of a deployed application instance changes to an application template with greater size (FIG. 11).

Based on to the datacenter hosting the application, the network entity 100 communicates with the corresponding cloud managing entity 10 and executes a Resources Information Request process in order to receive an updated Resources Status Notification message.

In case of sufficient resources availability on the selected datacenter, the network entity 100 allocates the necessary resources to the new application instance by moving the resources requested by the Application Template from the datacenter capacity value stored in its database. Then the network entity performs a disaster recovery plan update process and subsequently the instance scale out. Once the scale out process is completed, the network entity 100 is informed by the cloud managing entity 100 about the change of the infrastructure resources and by the network managing entity about the scale out process outcome.

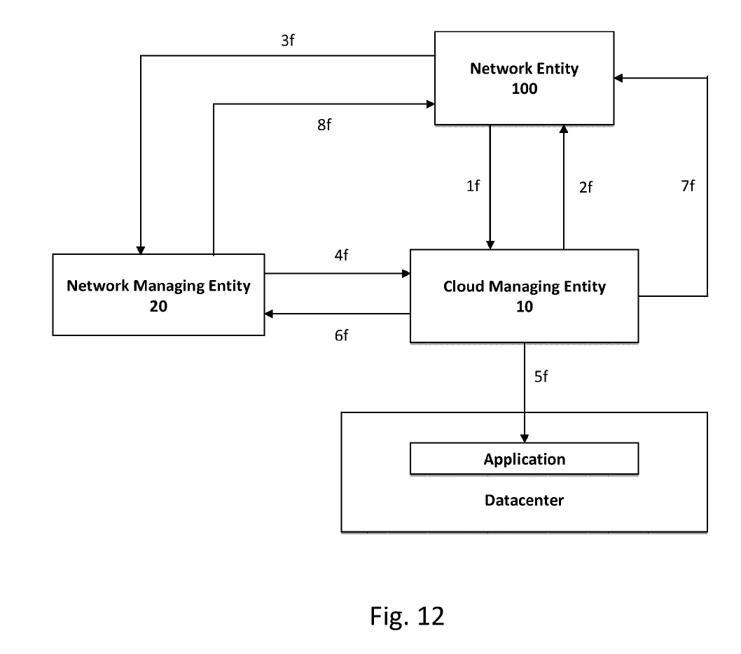

According to a first embodiment (FIG. 12), the scale out process is triggered by the network entity 100.

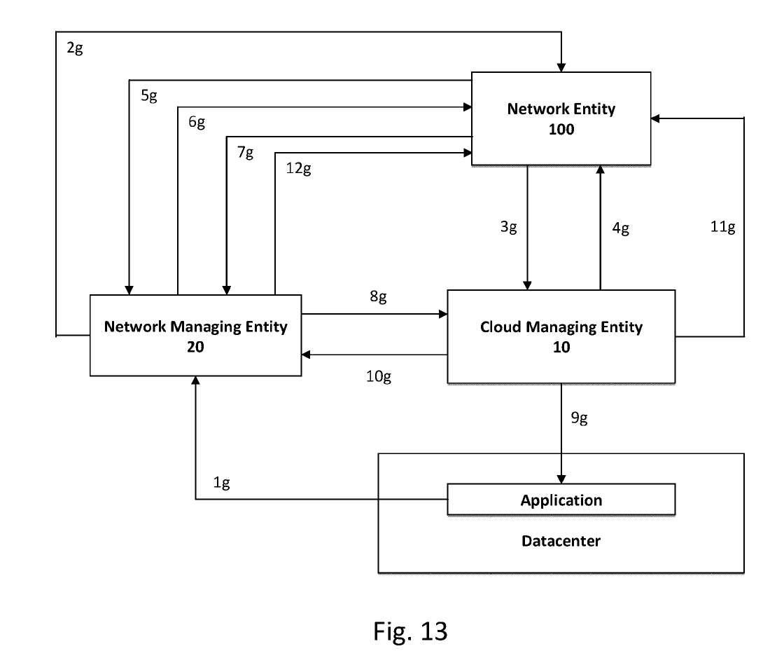

According to a second embodiment (FIG. 13), the scale out process is requested automatically by a network managing entity 20.

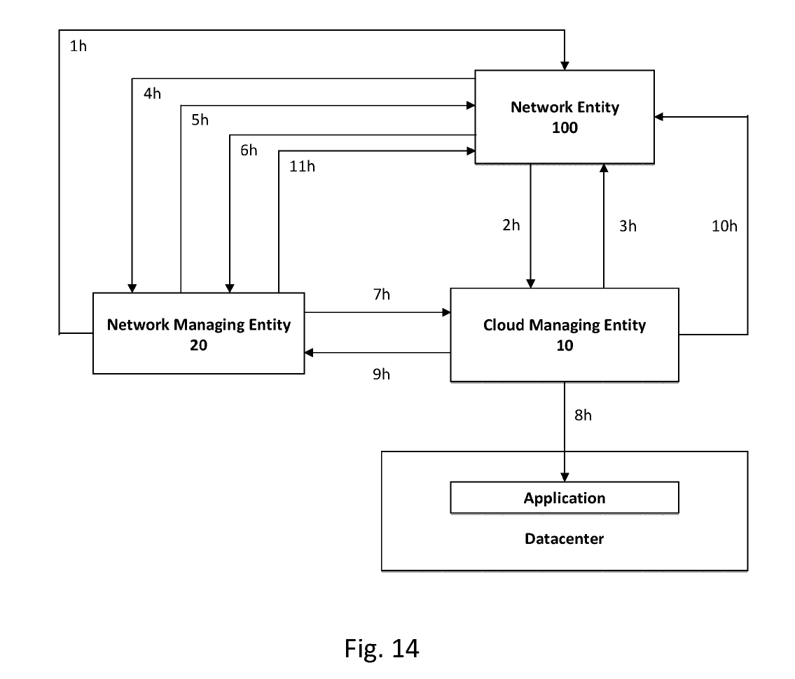

According to a third embodiment (FIG. 14), the scale out process is requested by an operator through a network managing entity 20.

According to the first embodiment (FIG. 12), the scale out process comprises the following steps:

1f) the network entity 100 sends a Resources Status Update Request message to the cloud managing entity 10,

2f) in response, the cloud managing entity 10 sends a Resources Status Notification message to the network entity 100,

3f) the network entity 100 verifies the availability of the resources required by the application template and sends to the related network managing entity 20 an Application

Instance Scale Out message to trigger the scale out process.

Preferably, this message includes the following data:
the network managing entity identification,
the application instance identification,
the application template size of the application instance to deploy,

4f) the network managing entity 20 sends a Scale Out Request message to the cloud managing entity 10 to scale out the application instance,

5f) the cloud managing entity 10 performs the scale out process requested,

6f) the cloud managing entity 10 sends a Scale Out Confirmation message to the network managing entity 20,

7f) the cloud managing entity 10 sends a New Resources Status Notification message to the network entity 100 to notify the network entity 100 about an infrastructure resources allocation change,

8f) the network managing entity 20 sends an Application Instance Scale Out Notification message to the network entity 100 to inform about the application instance scale out outcome.

According to the second embodiment (FIG. 13), the scale out process comprises the following steps:

1g) an application instance running on a datacenter sends an Application Instance Monitoring message to a network managing entity 20,

2g) the network managing entity 20 sends an Application Instance Scale Out Request message to the network entity 100 to trigger an application instance scale out process. Preferably, this message includes:
the network managing entity identification,
the application instance identification,
the application template size of the new application instance to deploy,

3g) the network entity 100 sends a Resources Status Update Request message to the cloud managing entity 10,

4g) in response, the cloud managing entity 10 sends a Resources Status Notification message to the network entity 100,

5g) the network entity 100 sends a Conditioned Response message to the network managing entity 20 if the value of the Resources Status Notification message does not allow to proceed with scale out. Otherwise, the network entity 100 sends an Application Instance Scale Out message (see step 7). Preferably, this message includes the following data:
the network managing entity identification,
the application instance identification,
the application template size of the application instance to deploy,
the identification of the datacenter where the instance will run,
the request outcome; in particular, the request outcome may have the following values:
   provisionally rejected, if there are not sufficient resources and the scale out can be performed by allocating resources dedicated to disaster recovery plan or by executing application rapid-elasticity;
   rejected, if there are not sufficient resources even by allocating resources dedicated to disaster recovery plan or by executing application rapid-elasticity;

6g) if the request outcome value is provisionally rejected, the network managing entity 20 sends an Application Instance Scale Out Confirmation message to the network entity 100. Preferably, this message includes:
the network managing entity identification,
the application instance identification,
the application template size of the application instance to deploy,
the identification of the datacenter where the instance will run,
confirmation which can have the following values: proceed or not proceed

7g) the network entity 100 verifies the availability of the resources required by the application template and sends to the related network managing entity 20 an Application Instance Scale Out message to trigger the scale out process.

Preferably, this message includes the following data:
the network managing entity identification,
the application instance identification,
the application template size of the application instance to deploy,

8g) the network managing entity 20 sends a Scale Out Request message to the cloud managing entity 10 to scale out the application instance,

9g) the cloud managing entity 10 performs the scale out process requested,

10g) the cloud managing entity 10 sends a Scale Out Confirmation message to the network managing entity 20,

11g) the cloud managing entity 10 sends a New Resources Status Notification message to the network entity 100 to notify the network entity 100 about an infrastructure resources allocation change,

12g) the network managing entity 20 sends an Application Instance Scale Out Notification message to the network entity 100 to inform about the application instance scale out outcome.

According to the third embodiment (FIG. 14), the scale out process comprises the following steps:

1h) the network managing entity 20 sends an Application Instance Scale Out Request message to the network entity 100 to trigger an application instance scale out process. Preferably, this message includes:
the network managing entity identification,
the application instance identification,
the application template size of the new application instance to deploy,

2h) the network entity 100 sends a Resources Status Update Request message to the cloud managing entity 10,

3h) in response, the cloud managing entity 10 sends a Resources Status Notification message to the network entity 100,

4h) the network entity 100 sends a Conditioned Response message to the network managing entity 20 if the value of the Resources Status Notification message does not allow to proceed with scale out. Otherwise, the network entity 100 sends an Application Instance Scale Out message (see step 7). Preferably, this message includes the following data:
the network managing entity identification,
the application instance identification,
the application template size of the application instance to deploy,
the identification of the datacenter where the instance will run,
the request outcome; in particular, the request outcome may have the following values:
   provisionally rejected, if there are not sufficient resources and the scale out can be performed by allocating resources dedicated to disaster recovery plan or by executing application rapid-elasticity;
   rejected, if there are not sufficient resources even by allocating resources dedicated to disaster recovery plan or by executing application rapid-elasticity;

5h) if the request outcome value is provisionally rejected, the network managing entity 20 sends an Application Instance Scale Out Confirmation message to the network entity 100. Preferably, this message includes:
the network managing entity identification,
the application instance identification,
the application template size of the application instance to deploy,
the identification of the datacenter where the instance will run,
confirmation which can have the following values: proceed or not proceed

6h) the network entity 100 verifies the availability of the resources required by the application template and sends to the related network managing entity 20 an Application Instance Scale Out message to trigger the scale out process.

Preferably, this message includes the following data:
the network managing entity identification,
the application instance identification,
the application template size of the application instance to deploy,

7h) the network managing entity 20 sends a Scale Out Request message to the cloud managing entity 10 to scale out the application instance.

8h) the cloud managing entity 10 performs the scale out process requested,

9h) the cloud managing entity 10 sends a Scale Out Confirmation message to the network managing entity 20,

10h) the cloud managing entity 10 sends a New Resources Status Notification message to the network entity 100 to notify the network entity 100 about an infrastructure resources allocation change,

11h) the network managing entity 20 sends an Application Instance Scale Out Notification message to the network entity 100 to inform about the application instance scale out outcome.

### Changing Allocation of Deployed Remote Resources for Use by a Network Element—Disaster Recovery

As stated above, for each datacenter, the network entity 100 is configured to store the amount of resources allocated for disaster recovery purposes for the applications hosted by each other datacenter.

In particular, the network entity 100 is configured to define and manage disaster recovery plans for applications to estimate unused resources capacity within each datacenter intended to be used in case of at least partially failure of an application.

Disaster recovery plans make available geographical redundancy of applications. A disaster recovery model for an application may be selected from one of the following models:
Active/Active (1 to N—over-dimensioned);
Active/Active (1 to N—not over-dimensioned);
Active/Stand-by (1+1);
Active/To Deploy.

According to the Active/Active (over-dimensioned) model, the traffic is simultaneously managed by application instances deployed through a plurality of datacenters and each application instance has sufficient capacity to sustain an additional traffic moved on this application instance upon workload redistribution of a failed application instance. In this case no action is required by the network entity 100.

According to the Active/Active (not over-dimensioned) model, the traffic is simultaneously managed by application instances deployed through a plurality of datacenters and each application instance has not sufficient capacity to sustain an additional traffic, such as an additional traffic moved on this application instance upon workload redistribution of a failed application instance. The network entity 100 is configured to estimate additional datacenter capacity in order to be able to execute a scale out process to a disaster recovery datacenter in case of failure of an application instance.

According to the Active/Stand-by model, an application instance processes the overall traffic and another stand-by application instance is pre-instantiated and configured in a different datacenter. In case of fault of the datacenter in which an application instance is hosted, the corresponding network managing entity 20 activates the stand-by instance application. In this case, no action is required by the network entity 100.

According to the Active/To Deploy model, an application relies on Virtualization Layer recovery mechanism in order to achieve redundancy. Also in this case the network entity 100 estimates the datacenter capacity in case of an application instance failure.

In case of application instantiation, the network entity 100 selects a main datacenter based on the information of application template. Based on the selection of the main datacenter and according to the application constraint and the disaster recovery model specified into the application template, the network entity 100 defines a disaster recovery plan. This disaster recovery plan is used in case of unavailability of an application.

### Disaster Recovery Plan Creation Process

The process for creating a disaster recovery plan is performed during an application instance deployment process.

This process selects a datacenter to be used as fail datacenter for disaster recovery purposes.

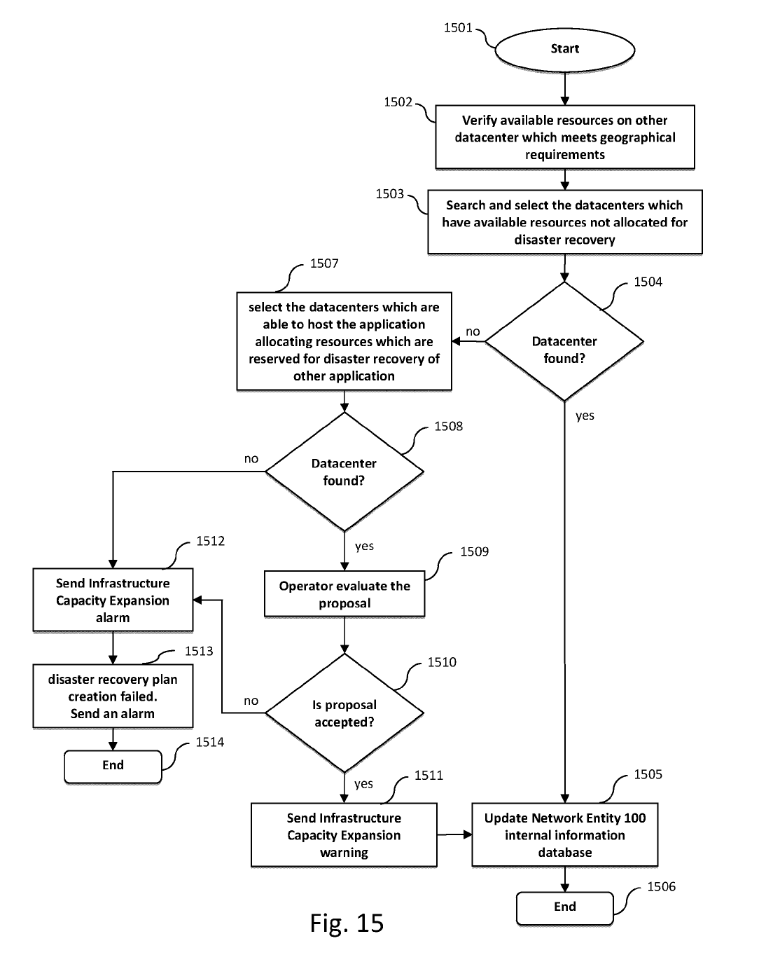

According to one embodiment (FIG. 15), the process for creating a disaster recovery plan for an application comprises the following steps performed by the network entity 100:

1) verify available resources on datacenters which meet geographical requirements of an application,

2) search and select the datacenters which have available resources not allocated for disaster recovery,

3) if a datacenter is found, the required resources are reserved into the selected datacenter and this information is stored and updated in the information database of the network entity 100 and the process ends,

4) if no datacenter is found, the process continues by searching and selecting the datacenters which are able to host the application allocating resources which are reserved for disaster recovery of other application,

5) if a datacenter is found, an operator action is required in order to accept or deny the selected database,

6) if no datacenter is found or the operator does not accept the selected database, the network entity 100 notifies that the datacenter is under-dimensioned, for example by sending an Infrastructure Capacity Alarm message, and that the disaster recovery plan creation process cannot be completed, for example by sending an Disaster Recovery Plan Creation Failed message; in this case, the specific application will not have a disaster recovery plan,

7) if the operator accepts the selected database a warning notification is generated to inform that the selected datacenter capacity is not sufficient for disaster recovery so that additional resources are needed and,

8) the amount of the additional resources needed for disaster recovery is stored and updated in the information database of the network entity 100 and the process ends.

### Disaster Recovery Plan Update Process

Use of application resources may vary upon performing a scale in or a scale out process.

Advantageously, disaster recovery plans are updated in view of the use of application resources.

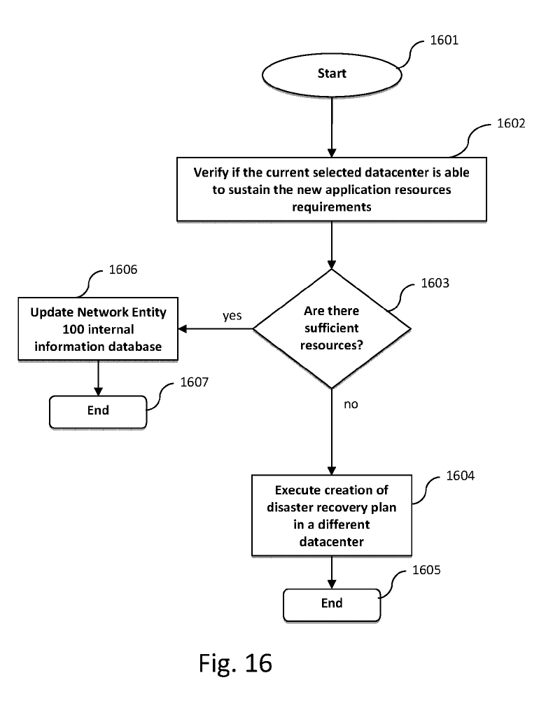

According to one embodiment (FIG. 16), the process for updating a disaster recovery plan for an application comprises the following steps performed by the network entity 100:

1) the network entity 100 verifies if the application resources requirements, in particular the application template size, are met by the current selected disaster recovery datacenter.

2) if the current selected disaster recovery datacenter is sufficient, an internal database of the network entity 100 is updated with the above information,

3) if the current selected disaster recovery datacenter is not sufficient, the network entity 100 performs the process for creating a disaster recovery plan in a different datacenter.

### Disaster Recovery Plan Availability Resources Check

When the network entity 100 receives a notification about a change in the available resources of a datacenter, the network entity 100 performs a process for checking the availability resources for disaster recovery plan.

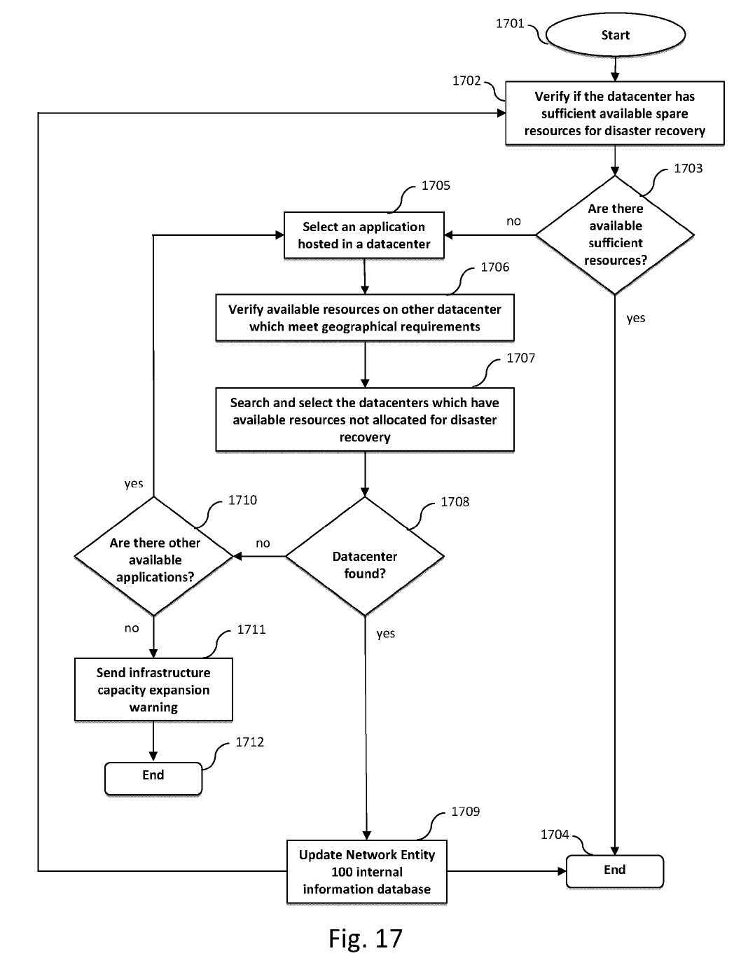

According to one embodiment (FIG. 17), the process comprises the following steps:

1) the network entity 100 verifies if the datacenter has sufficient available resources for disaster recovery, no action is required by the network entity 100,

2) if the datacenter has not sufficient available resources for disaster recovery, the network entity 100 operates to move disaster recovery plans for application to other datacenter; in particular, the network entity 100 selects an application hosted in the datacenter,

3) the network entity 100 verifies if a datacenter exists which is able to meet the application requirements without making use of resources allocated for disaster recovery of other applications,

4) if the datacenter is found, the required resources are allocated in the selected datacenter and removed from the original datacenter and an internal database of the network entity 100 is updated with the above information,

5) if no datacenter is found, the network entity 100 verifies if there are other available applications and selects one application and returns to step 3),

6) if there are not available applications, the network entity 100 sends an Infrastructure Capacity Expansion warning indicating that the datacenter is not able to support fail of all hosted applications.

### Datacenter Capacity Planning

The network entity 100 is configured to estimate the capacity expansion of a datacenter.

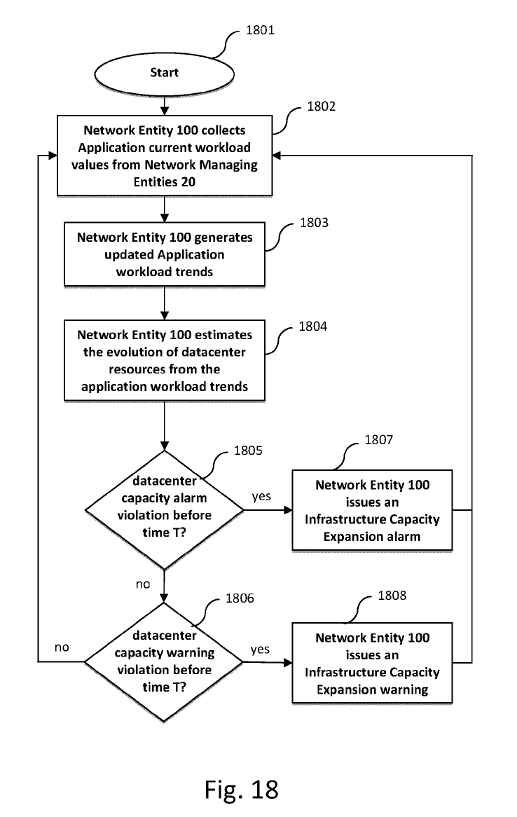

According to a preferred embodiment (FIG. 18), the estimation of the capacity expansion of a datacenter comprises the following steps:

1) the network entity 100 sends to each network managing entity 20 an Application Instances Workload Update Request message to receive an Application Instances Workload Update Notification message with the workload values,

2) Based on the workload values, the network entity 100 generates the historical trends of each application workload and estimates the evolution of the datacenter resources,

3) Preferably the network entity 100 has two thresholds for the available resources; if the network entity 100 estimates that, at a time T, there is a high probability that a specific datacenter has an amount of available resources lower than one of the two thresholds, an Infrastructure Capacity Expansion warning or alarm is issued by the network entity 100, depending on which threshold is violated.

Preferably, the comparison between the available resources with the two thresholds is performed by comparing the remaining amount of available GHz CPU, GB RAM and GB storage with specific thresholds of these resources.

It is worthwhile to note that, at step 2), for each datacenter capacity planning, the network entity 100 estimates the evolution of all applications running in different datacenters and making use of resources on the considered datacenter. In fact, if one of the application performs a scale in/out process, also the requested resources for the associated disaster recovery plan will change thereby modifying the amount of resources used in a different datacenter.

The network entity 100 is therefore able to process the estimated amount of resources to be used by an application at a given time and the corresponding disaster recovery information, including disaster recovery model and disaster recovery datacenter, to estimate the resources capacity requirement of all datacenters.

In addition, as the cloud managing entity 10 periodically sends to the network entity 100 a message with the total amount of resources of each datacenter, the network entity 100 is able to estimate the total amount of available resources of all datacenters, not allocated for disaster recovery purposes.

While the invention has been described with reference to preferred embodiments, the description is illustrative of the invention and is not to be construed as limiting the invention.

Various modifications and applications may occur to those skilled in the art without departing from the scope of the invention as defined by the appended claims.

It is to be understood that the above description is given by way of example and only for the benefit of understanding the solution, and it must include also any combination of the above features, as well as any alterations, modifications or otherwise addition which could be done by a skilled person by use of his/her skills and/or general knowledge in the relevant and/or neighbouring art.

1. A network entity (100) for managing resource allocation in a mobile telecommunication network (1), said network entity (100) comprising:
a first interface (101) configured to enable said network entity (100) to communicate with one or more cloud managing entities (10), wherein each of said one or more cloud managing entities (10) manages respective remote resources (50), and
a second interface (102) configured to enable said network entity (100) to control operations between one or more network managing entities (20) and said one or more cloud managing entities (10), wherein each of said one or more network managing entities (20) manages respective network elements (60),
wherein said network entity (100) is configured to perform a first function, said first function including exchanging information with said one or more cloud managing entities (10) over said first interface (101) and controlling the operations between said one or more network managing entities (20) and said one or more cloud managing entities (10) based on said information, said information comprising a status of at least one of the respective remote resources (50) managed by said one or more cloud managing entities (10).

2. The network entity (100) according to claim 1, wherein said network entity (100) is further configured to determine whether at least one of the network elements (60) requires use of remote resources and/or modification of use of remote resources and/or management of allocation of remote resources for use in disaster recovery.

3. The network entity (100) according to claim 2, wherein the determination is based on an indication, received from one or more network managing entities (20) over said second interface (102), that at least one of the respective network elements (60) requires use of remote resources.

4. The network entity (100) according to claim 2, wherein the determination is performed autonomously by the network entity (100), preferably based on a prediction of future use of remote resources by at least one of the network elements (60).

5. The network entity (100) according to any of claims 1 to 4, wherein said information enable said network entity (100) to determine whether the at least one of the respective remote resources (50) are available for use by at least one of the network elements (60).

6. The network entity (100) according to any of claims 1 to 5, wherein said operations comprise at least one of:
triggering deployment of at least one of the remote resources (50) for use by at least one of the network elements (60);
modifying existing deployment of at least one of the remote resources (50) for use by at least one of the network elements (60); and
changing current or future allocation of remote resources (50) for use by at least one of the network elements (60).

7. The network entity (100) according to any of claims 1 to 6, wherein said information enable said network entity (100) to determine and/or verify a disaster recovery plan for at least one of the remote resources (50).

8. The network entity (100) according to any of claims 1 to 7, wherein said network entity (100) is configured to:
manage, for each datacenter of a plurality of datacenters, allocation and/or modification of a set of disaster recovery remote resources to be used in case of at least partial failure of an application, and
store, for each datacenter of said plurality of datacenters, information about disaster recovery remote resources allocated for the applications hosted by each other datacenter of said plurality of datacenters.

9. The network entity (100) according to claim 8, wherein, for each application of a plurality of applications, said allocation of a set of disaster recovery remote resources is based on availability of remote resources not previously allocated for disaster recovery.

10. The network entity (100) according to claim 9, wherein, in case of unavailability of remote resources not previously allocated for disaster recovery of other applications, said allocation is further based on availability of remote resources previously allocated for disaster recovery of other applications of said plurality of applications.

11. The network entity (100) according to any of claims 8-10, wherein, for each application of a plurality of applications, said modification of a set of disaster recovery remote resources is based on a comparison of remote resources to be used for said application with actual disaster recovery resources allocated for said application.

12. The network entity (100) according to any of claims 1 to 11, wherein:
said network entity (100) is further configured to perform a second function,
said second function allows the network entity (100) to manage service templates associated to one or more applications defining a service.

13. The network entity (100) according to claim 12, wherein:
said network entity (100) comprises a first network sub-entity (111) configured to perform said first function and a second network sub-entity (112) configured to perform said second function,
each application is instantiated by a corresponding application instance loaded and running on a respective network element (60),
said second network sub-entity (112) is configured to perform said second function on the basis of one or more application instances available through respective one or more first network sub-entities (111).

14. A system (1) for managing resource allocation in a mobile telecommunication network, said system (1) comprising:
a network entity (100) for managing resource allocation,
one or more cloud managing entities (10), each of said one or more cloud managing entities (10) managing respective remote resources,
one or more network managing entities (20) each of said one or more network managing entities (20) managing respective network elements,
wherein said network entity (100) comprises:
a first interface (101) configured to enable said network entity (100) to communicate with said one or more cloud managing entities (10) and
a second interface (102) configured to enable said network entity (100) to control operations between said one or more network managing entities (20) and said one or more cloud managing entities (10),
wherein said network entity (100) is configured to perform a first function, said first function including exchanging information with said one or more cloud managing entities (10) over said first interface (101) and controlling the operations between said one or more network managing entities (20) and said one or more cloud managing entities (10) based on said information, said information comprising a status of at least one of the respective remote resources (50) managed by said one or more cloud managing entities (10).
